(19) United States
(12) Patent Application Publication
(10) Pub. No.: US 2007/0043474 A1
(43) Pub. Date: Feb. 22, 2007

(54) Systems and methods for predicting process characteristics of an electrochemical treatment process

(75) Inventor: John Klocke, Kalispell, MT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Semitool, Inc.

(21) Appl. No.: 11/207,163

(22) Filed: Aug. 17, 2005

(51) Int. Cl. G05B 21/00

(52) U.S. Cl. 700/266

(57) ABSTRACT

Methods and systems for managing a process for electrochemically treating a surface of a microfeature workpiece in an electrochemical treatment chamber that includes a processing unit for receiving a first processing fluid separated by an ion-permeable barrier from an electrode unit for receiving a second processing fluid are described. The methods and systems provide the operator the ability to effectively troubleshoot, evaluate, and modify electrochemical treatment processes so that effective results can be achieved and cost savings realized.

### FIELD OF THE INVENTION

The present invention relates to systems and methods for managing electrochemical treatment processes that employ an ion-permeable barrier separating a first processing fluid in a processing unit from a second processing fluid in an electrode unit. In certain embodiments, values predicted for process characteristics in accordance with the invention can be used to troubleshoot the process. In other embodiments, the predicted values can be used to evaluate production capacity for the process and evaluate how changes to the process affect equilibrium conditions for the first processing fluid and/or the second processing fluid.

### BACKGROUND OF THE INVENTION

Microelectronic devices, such as semiconductor devices, imagers, and displays, are generally fabricated on and/or in microelectronic workpieces using several different types of machines, otherwise known as tools. Such processing machines often include a plurality of processing stations that perform the same procedures on a plurality of workpieces. Other processing machines include a plurality of these processing stations that perform a series of the same or different procedures on individual workpieces or batches of workpieces. For example, these processing stations can be used to carry out electroplating, electrophoretic deposition, electroetching, electropolishing, anodization, or electroless plating procedures. In a typical fabrication process, one or more layers of conductive materials are formed on the workpieces during deposition stages. The workpieces are then typically subjected to etching and/or polishing procedures (e.g., planarization) to remove a portion of the deposited conductive layers and form electrically isolated contacts and/or conductive lines.

Tools that plate, etch, polish and anodize metals or other materials on workpieces are becoming an increasingly useful type of processing machine. These procedures can be used to process copper, solder, gold, silver, platinum, nickel, metal alloys, and other materials that are useful in the manufacture of microfeature workpieces. A typical copper plating process involves depositing a copper seed layer onto the surface of a workpiece using chemical vapor deposition (CVD), physical vapor deposition (PVD), electroless plating processes, or other suitable methods. After forming the seed layer, a blanket layer or patterned layer of copper is plated onto the workpiece by applying an appropriate electrical potential between the seed layer and an anode in the presence of an electroprocessing solution. The workpiece is then cleaned, etched, and/or annealed in subsequent procedures.

In U.S. Application Publication No. 2005/0087439 A1, it is proposed to employ an electrochemical deposition chamber with a non-porous barrier separating processing fluids. The described chamber is divided into two distinct systems that interact with each other to electroplate a material onto the workpiece while controlling migration of selected components in the processing fluids (e.g., organic additives) across the non-porous barrier. Materials that can be electroplated onto the workpiece include metals that can be placed into an ionic form in the processing fluids. For example, copper, gold, silver, platinum, nickel, metal alloys, solder, and other metals can be deposited onto the workpiece.

A schematic illustration of an electrochemical deposition chamber 10 of Application Serial No. 2005/0087439 A1 is illustrated in FIG. 1. Chamber 10 includes a processing unit 12 that provides a first processing fluid 14 (e.g., a catholyte) to a workpiece 16 (i.e., working electrode), and an electrode unit 18 that provides a second processing fluid 20 (e.g., anolyte) different than the first processing fluid 14, and an electrode 22 (i.e., counterelectrode). The catholyte typically contains components in the form of ionic species such as acid ions and metal ions. The catholyte also includes organic components, such as accelerators, suppressors, and levelers that improve the results of the electroplating process. The anolyte includes ionic components such as acid ions and metal ions. Unlike the catholyte, the anolyte typically does not include organic components. Chamber 10 also includes a non-porous barrier 24 between the first processing fluid 14 and the second processing fluid 20. Non-porous barrier 24 allows ions (e.g., H⁺ and Cu²⁺) to pass through the barrier, but inhibits organic components (e.g., accelerators, suppressors, and levelers) from passing between the first and second processing fluids. As such, non-porous barrier 24 separates components of the first and second processing fluids from each other such that the first processing fluid can have different chemical characteristics than the second processing fluid. As explained above, the first processing fluid can be a catholyte containing organic components and the second processing fluid can be an anolyte without organic components or a much lower concentration of such components. The first processing fluid may also contain metal ions and acid ions at different concentrations than the second processing fluid.

The non-porous barrier of U.S. Application Publication No. 2005/0087439 A1 provides several advantages by substantially preventing the organic components in the catholyte from migrating to the anolyte. First, because organic components from the catholyte are prevented from transferring to the anolyte, they cannot flow past the anode and decompose into products that may interfere with the plating process. Second, because the organic components do not pass from the catholyte to the anolyte and then decompose at the anode, they are consumed at a slower rate so it is less expensive and easier to control the concentration of organic components in the catholyte. Third, less expensive anodes, such as pure copper anodes or bulk copper material, can be used in the anolyte because the risk of passivation or decomposition by reaction of the anode with organic components is reduced or eliminated.

In electrochemical treatment processes carried out in a tool containing such types of chambers, many variables can affect the characteristics of the first processing fluid and directly impact the chemistry that is delivered to the workpiece. Examples of such variables include size of the workpieces, number of chambers in the tool, tool usage/day, starting catholyte metal ion concentration, starting catholyte acid concentration, catholyte volume, starting anolyte metal ion concentration, starting anolyte pH, anolyte volume, ion-permeable barrier area, total active ion-permeable barrier area, average current, and the current density across the ion-permeable barrier. With an objective of delivering a first processing fluid chemistry to the workpiece that meets the specifications for the process over an extended period of time, workpiece processors are understandably concerned with the effects these variables have on the chemistry. For example, microfeature workpiece manufacturers desire to operate chambers at steady state/equilibrium conditions characterized by little or no change in catholyte and anolyte compositions over time for as long as possible. The ability to predict how specific process characteristics will affect equilibrium conditions for the process fluids or other process characteristics is valued by microfeature workpiece manufacturers. By understanding the effects the variables have on the processing fluid chemistry, workpiece processors can better monitor and control the process in a manner that results in reduced chemical usage and service requirements, resulting in lower operating costs. For example, ascertaining whether chosen starting compositions for the catholyte and anolyte chemistry will result in desired chemistry equilibrium conditions would be of value to the workpiece manufacturer. Providing a microfeature workpiece manufacturer with an ability to understand how process characteristics other than the catholyte and anolyte chemistries affect the process, would also provide significant value to microfeature workpiece manufacturers.

### SUMMARY OF THE INVENTION

The present invention provides systems and methods that microfeature workpiece manufacturers can use to manage electrochemical treatment processes. Use of systems and methods of the present invention provide microfeature workpiece processors with the ability to reduce production costs while maintaining production quality. The systems and methods allow the user to predict characteristics of the electrochemical treatment process and evaluate how those characteristics affect the results of the process and how characteristics of the process might be changed to achieve the desired results. For example, systems and methods of the present invention allow microfeature workpiece manufacturers to troubleshoot an electrochemical treatment process, evaluate production capacity of the process, and evaluate changes to the process characteristics that affect equilibrium conditions for the anolyte and catholyte. Methods and systems of the present invention are useful in processes for electrochemically treating a surface of a workpiece. The present invention is not limited to a specific electrochemical treatment process or to any specific metal ions, with copper, gold, silver, platinum, solder, nickel, metal alloys, and solder being examples of suitable metals. Electroplating, electrophoretic deposition, electroetching, electropolishing, anodization, and electroless plating procedures are examples of electrochemical treatment processes that can benefit from the methods and systems of the present invention.

In accordance with methods of managing a process for electrochemically treating a surface of a microfeature workpiece in accordance with the present invention, a value for a first characteristic of the process is predicted using a relationship between values for at least two characteristics of the process when the process is at equilibrium. For example, the equilibrium catholyte metal ion concentration can be predicted from a relationship between ion-permeable barrier current density and anolyte equilibrium pH. The predicted value of the first characteristic can be used to evaluate whether a change to another characteristic of the process is necessary. For example, the predicted equilibrium catholyte metal ion concentration can be compared to the equilibrium catholyte metal ion concentration process specification and a determination made as to whether a change to another process characteristic, such as the starting catholyte metal ion concentration or the starting anolyte metal ion concentration, is necessary in order to achieve the equilibrium catholyte metal ion concentration set by the process specification. The effect changes to other process characteristics have on the equilibrium catholyte metal ion concentration can be evaluated using methods of the present invention. In addition, the predicted value of the first characteristic can be used to troubleshoot the process.

Systems for managing an electrochemical treatment process of a microfeature workpiece formed in accordance with the present invention include an electrochemical treatment chamber having a processing unit for receiving a first processing fluid separated by an ion-permeable barrier from an electrode unit for receiving a second processing fluid. The system further includes a prediction module for predicting a first characteristic of the process carried out in the electrochemical treatment chamber. The prediction module uses a relationship between values for at least two characteristics of the process when the process is at equilibrium to predict a value for the first characteristic of the process. That predicted value for the first characteristic of the process is used by an evaluation module to evaluate whether a change to another characteristic of the process is necessary and the effect of such changes on the process.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram of an electrochemical treatment chamber in accordance with the prior art;

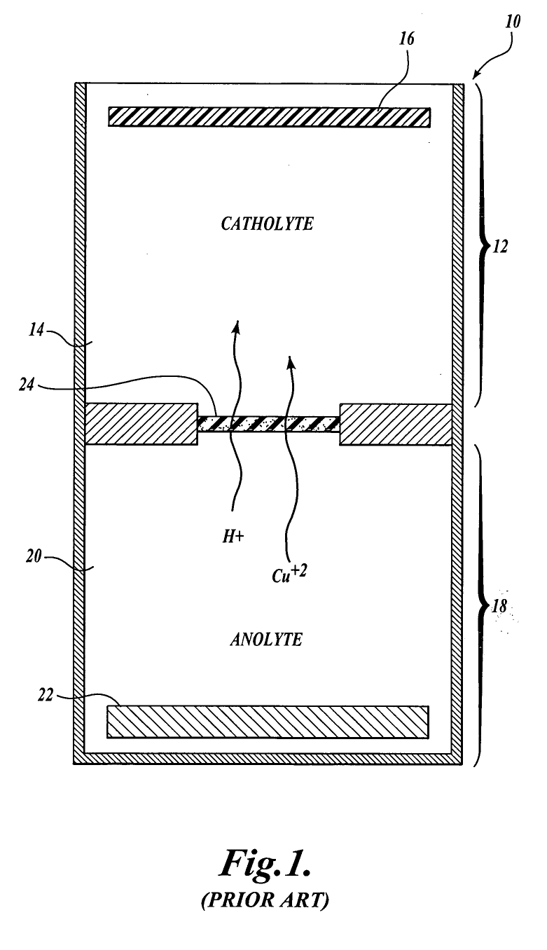

FIG. 2 is a schematic illustration of a system for electrochemically treating a microfeature workpiece;

FIG. 3 is a schematic flow chart of steps involved in a method carried out in accordance with the present invention;

FIG. 4 is a graph illustrating a relationship between anolyte equilibrium pH and ion-permeable barrier current density;

FIG. 5 is a flow chart illustrating a process for determining ion-permeable barrier current density in accordance with the present invention;

FIG. 6 is a flow chart illustrating a process for predicting catholyte equilibrium acid concentration in accordance with the present invention;

FIG. 7 is a flow chart illustrating a process for predicting equilibrium anolyte and catholyte metal ion concentration in accordance with the present invention; and

FIG. 8 is a schematic illustration of a system for managing an electrochemical treatment process formed in accordance with the present invention.

### DETAILED DESCRIPTION OF THE PREFERRED EMBODIMENT

As used herein, the terms “microfeature workpiece” or “workpiece” refer to substrates on and/or in which microdevices are formed. Typical microdevices include microelectronic circuits or components, thin film recording heads, data storage elements, micro fluidic devices, and other products. Micro machines or micro mechanical devices are included within this definition because they are manufactured using much of the same technology as used in the fabrication of integrated circuits. The substrates can be semiconductive pieces (e.g., silicon wafers or gallium arsenide wafers), nonconductive pieces (e.g., various ceramic substrates), or conductive pieces (e.g., doped wafers). Also, the term electrochemical processing or treatment includes electroplating, electrophoretic deposition, electroetching, electropolishing, anodization, and/or electroless plating.

In the description that follows, specific reference is made to copper as an example of a metal ion that can be electroplated onto a microfeature workpiece. The reference to copper ions is for exemplary purposes and it should be understood that the present invention is not limited to copper. Furthermore, the reference to electroplating is for exemplary purposes and it should be understood that the present invention is not limited to electroplating processes. The present invention is useful with metals in addition to copper as well as electrochemical processes other than electroplating.

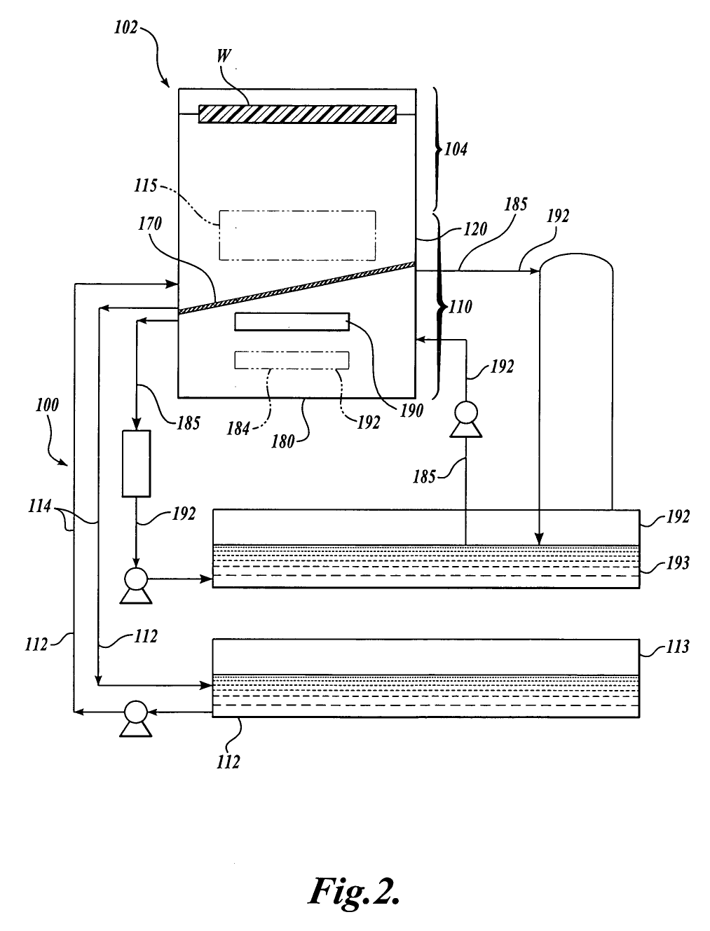

Methods and systems of the present invention are used to manage electrochemical treatment processes. FIG. 2 schematically illustrates a system 100 for electrochemical treatment of microfeature workpieces. The system 100 includes an electrochemical treatment chamber 102 having a head assembly 104 (shown schematically) and a wet chemical vessel 110 (shown schematically). The head assembly 104 loads, unloads, and positions a workpiece W or a batch of workpieces at a processing site relative to the vessel 110. The head assembly 104 typically includes a workpiece holder having a contact assembly with a plurality of electrical contacts configured to engage a conductive layer on the workpiece W. The workpiece holder can accordingly apply an electric potential to the conductive layer on the workpiece W. Suitable head assemblies, workpiece holders, and contact assemblies are disclosed in U.S. Pat. Nos. 6,228,232; 6,280,583; 6,303,010; 6,309,520; 6,309,524; 6,471,913; 6,527,925; 6,569,297; 6,780,374; and 6,773.560.

The illustrated vessel 110 includes a processing unit 120 (shown schematically), an electrode unit 180 (shown schematically), and an ion-permeable barrier 170 (shown schematically) between the processing and electrode units 120 and 180. The processing unit 120 is configured to contain a first processing fluid for processing the microfeature workpiece W. The electrode unit 180 is configured to contain an electrode 190 and a second processing fluid at least proximate to the electrode 190. The second processing fluid is generally different than the first processing fluid, but they can be the same in some applications. In general, the first and second processing fluids have some ions in common. For example, the first processing fluid in the processing unit 120 is a catholyte and the second processing fluid in the electrode unit 180 is an anolyte when the workpiece is cathodic. In electropolishing or other treatment processes, however, the first processing fluid can be an anolyte and the second processing fluid can be a catholyte.

System 100 further includes a first flow system 112 that stores and circulates the first processing fluid and a second flow system 192 that stores and circulates the second processing fluid. The first flow system 112 may include a first processing fluid reservoir 113, a plurality of fluid conduits 114 to convey a flow of the first processing fluid between the first processing fluid reservoir 113 and the processing unit 120. Component(s) 115 (shown schematically) in processing unit 120 are used to convey a flow of the first processing fluid to the processing site. First processing fluid is delivered directly to processing unit 120 by having the inlet of a conduit 114 from first processing fluid reservoir 113 enter directly into processing unit 120 above barrier 170.

The second flow system 192 may include a second processing fluid reservoir 193, a plurality of fluid conduits 185 to convey the flow of the second processing fluid between the second processing fluid reservoir 193 and the electrode unit 180, and component(s) 184 (shown schematically) in the electrode unit 180 to convey the flow of the second processing fluid across the electrode(s) 190. The concentrations of individual components of the first and second processing fluids can be controlled separately in the first and second processing fluid reservoirs 113 and 193, respectively. For example, metals ions, such as copper ions, can be added to the first and/or second processing fluid in the respective reservoir 113 or 193. Additionally, the temperature of the first and second processing fluids and/or removal of undesirable materials or bubbles can be controlled separately in the first and second flow systems 112 and 192.

An ion-permeable barrier 170 is positioned between the first and second processing fluids in the region of the interface between the processing unit 120 and the electrode unit 180 to separate the first processing fluid from the second processing fluid. For example, an ion-permeable barrier 170 inhibits fluid flow between the first and second flow systems 112 and 192 while selectively allowing ions, such as cations or anions, to pass through the ion-permeable barrier 170 between the first and second processing fluids. As such, an electric field, a charge imbalance between the processing fluids, and/or differences in the concentration of components in the processing fluids can drive ions across the barrier 170 as described in detail below.

Barrier 170 is an ion-permeable barrier, one example of which is a non-porous barrier such as a semi-permeable ion exchange membrane. A semi-permeable ionic exchange membrane allows cations or anions to pass but not both. A non-porous barrier substantially inhibits fluid flow between the first processing fluid and the second processing fluid within chamber 102 while selectively allowing ions, such as cations or anions, to pass through the non-porous barrier, and between the first and second processing fluids. In comparison to porous barriers, nonporous barriers are characterized by having little or no porosity or open space. In addition, in a normal electroplating chamber, non-porous barriers generally do not permit fluid flow when the pressure differential across the barrier is less than about 6 psi.

In contrast to porous barriers, such as filter media, expanded Teflon® (GORE-TEX®), and fritted materials (glass, quartz, ceramic, etc.), a nonporous barrier substantially inhibits organic species and fluids, from passing through the barrier. Because the nonporous barriers are substantially free of open area, fluid is inhibited from passing through the nonporous barrier when the first and second flow systems operate at typical pressures. Water, however, can be transported through the nonporous barrier via osmosis and/or electro-osmosis. Osmosis can occur when the molar concentrations in the first and second processing fluids are substantially different. Electro-osmosis can occur as water is carried through the nonporous barrier with current carrying ions in the form of a hydration sphere. When the first and second processing fluids have similar molar concentrations and no electrical current is passed through the processing fluids, fluid flow between the first and second processing fluids through the nonporous barrier is substantially prevented.

A non-porous barrier can be hydrophilic so that bubbles in the processing fluids do not cause portions of the barrier to dry, which reduces conductivity through the barrier. Suitable nonporous barriers include Nafion® membranes manufactured by DuPont®, lonac® membranes manufactured by Sybron Chemicals Inc., and NeoSepta™ membranes manufactured by Tokuyuma.

When the system 100 is used for electrochemical processing, an electric potential can be applied to the electrode 190 and the workpiece W such that the electrode 190 is an anode and the workpiece W is a cathode. The first and second processing fluids are accordingly a catholyte and an anolyte, respectively, and each fluid can include a solution of metal ions to be plated onto the workpiece W. The electric field between the electrode 190 and the workpiece W will drive positive ions through the barrier 170 from the anolyte to the catholyte, or drive negative ions in the opposite direction. In plating applications, an electrochemical reaction occurs at the microfeature workpiece W in which metal ions are reduced to form a solid layer of metal on the microfeature workpiece W. In electrochemical etching or electropolishing and other electrochemical applications, the electrical field may drive ions the opposite direction.

During an electroplating process, it is desirable to control the concentration of materials in the first processing fluid to ensure consistent, repeatable depositions on a large number of individual microfeature workpieces. For example, when copper is deposited on the workpiece W, it is desirable to maintain the concentration of copper in the first processing fluid (e.g., the catholyte) within a desired range to repeatedly deposit a suitable layer of copper on the workpieces W.

From the discussion above, it can be understood that characteristics of an electrochemical treatment process such as the type of an ion-permeable barrier, the chemical composition of the first processing fluid and the second processing fluid, and the volume of the first processing fluid and the second processing fluid impact the results achieved by an electrochemical treatment process. In addition to the foregoing characteristics, the size of the workpieces, the number of chambers in a tool, the amount of tool usage per day, the ion-permeable barrier area per chamber, the total active ion-permeable barrier area for the tool, the average current, and the ion-permeable barrier current density can impact the results of the electrochemical treatment process by affecting, among other things, the condition of the chemistry delivered to the workpiece, e.g., when the electrode is cathodic, the catholyte chemistry.

In accordance with one aspect of the present invention, methods to manage an electrochemical treatment process predict a value of a characteristic of the process and use the predicted value of the characteristic to evaluate whether changes to other characteristics of the process are necessary. For example, the methods can be used to determine if an electrochemical treatment process is operating properly. The methods allow microfeature workpiece processors to troubleshoot the process, e.g., to determine if catholyte is leaking into the anolyte solution, determine if anolyte is leaking into the catholyte solution, whether undesired bath dilution or concentration is occurring, evaluate shifts in bath concentrations, and/or evaluate the operation of hardware. The methods are also useful to evaluate production capacity of an electrochemical treatment process and evaluate the effect that changes to certain process characteristics have on other process characteristics. For example, using a method of the present invention, a microfeature workpiece processor can determine: if a particular catholyte/anolyte chemistry will be able to sustain a desired production level given its current state: how much plating is needed to keep a catholyte chemistry within process specifications: the number of chambers required to maintain the catholyte chemistry within the process specification: and whether or not an anolyte chemistry needs to be replaced when a catholyte chemistry is replaced. Furthermore, methods of the present invention are useful in a chemistry control system that provides suggested process changes to maintain the catholyte chemistry within process specifications. Specific embodiments of methods of the present invention are described below in more detail.

As used herein, process specifications refers to values of process characteristics that have been set, e.g., by the tool manufacturer or the tool operator, so that a desired result is achieved by the electrochemical treatment process. For example, a process specification for a catholyte chemistry may dictate a target range for metal ion concentration and acid concentration.

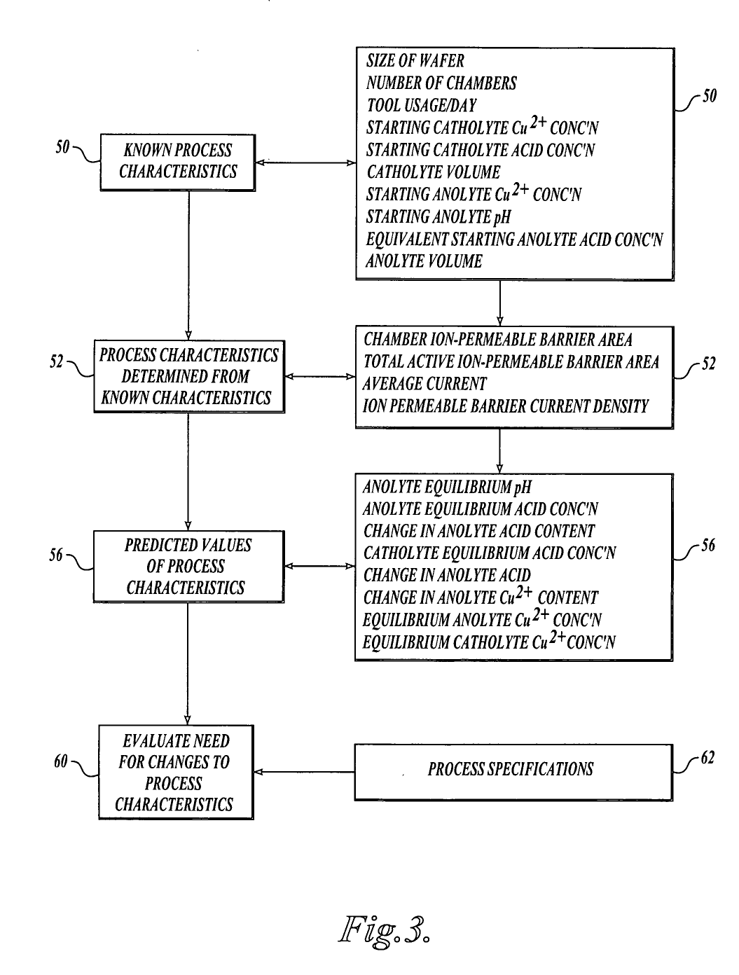

Referring to FIG. 3, a schematic illustration of a method in accordance with the present invention to predict, among other things, catholyte pH and metal ion concentration at equilibrium is illustrated. In the following discussion, copper is referenced as the metal ion for illustrative purposes; however, it should be understood that the following description applies to electrochemical treatment processes that use other metal ions. As illustrated in FIG. 3, characteristics 50 of an electrochemical treatment process that are known, or can be readily determined at the time of startup, or at another time during a production cycle, include:
size of wafer (mm)
number of chambers in the tool
tool usage per day (amp-min/day)
starting catholyte Cu²⁺ concentration (grams/liter)
starting catholyte acid concentration (grams/liter)
starting anolyte Cu²⁺ concentration (grams/liter)
starting anolyte pH
equivalent starting anolyte acid concentration (grams/liter)
catholyte volume (liter)
anolyte volume (liter)

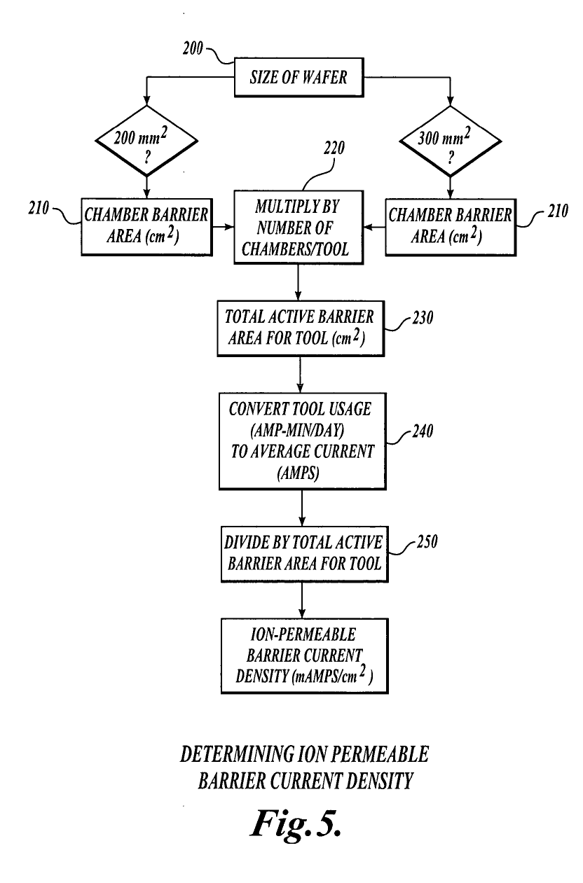

From the known characteristics 50, the process characteristics 52 can be determined as described below in more detail with reference to FIGS. 5-7:
chamber ion-permeable barrier area (cm²)
total active ion-permeable barrier area for the tool (cm²)
average current (amps)
ion-permeable barrier current density (mAmps/cm²)

The foregoing characteristics 52 of the process are then used to predict values of process characteristics 56 such as:
anolyte equilibrium (pH)
anolyte equilibrium acid concentration (grams/liter)
catholyte equilibrium acid concentration (grams/liter)
change in anolyte acid content (grams)
change in anolyte acid (moles)
change in anolyte Cu²⁺ content (grams)
equilibrium anolyte Cu²⁺ concentration (grams/liter)
equilibrium catholyte Cu²⁺ concentration (grams/liter).
   as described below in more detail with reference to FIGS. 5-7.

As mentioned above, predicted values 56 of the electrochemical treatment process characteristics are used at 60 to evaluate whether changes in other process characteristics are necessary to achieve predetermined objectives, e.g., maintaining anolyte pH and catholyte Cu²⁺ concentration at equilibrium within process specifications 62. For example, when the objective is to maintain catholyte Cu²⁺ or anolyte pH within process specifications at equilibrium, and the predicted Cu²⁺ concentration at equilibrium or anolyte pH fall outside the process specification, changes to other characteristics of the process may be necessary to achieve the desired catholyte equilibrium composition. For example, if the predicted value for the equilibrium catholyte Cu²⁺ is too high, an increased level of plating can be implemented or treatment chambers can be taken offline. If the predicted value for the equilibrium catholyte Cu²⁺ concentration is too low, anolyte replacement may be necessary. If the predicted value for the equilibrium anolyte pH is too high, acid can be added to the anolyte, tool usage can be reduced or treatment chambers can be taken out of an idle state. If the predicted value for the equilibrium pH of the anolyte is too low, anolyte may need replacement, tool usage can be increased or an auxiliary electrode can be put into operation.

When changes are needed, the proposed changes to the process characteristics can be evaluated to determine if the changes are sufficient to cause the equilibrium catholyte chemistry to satisfy the process specifications. The proposed changes to the process characteristics will define new values for known characteristics 50 and process characteristics 52 determined from the new known characteristics 50, which are then used to predict new values 56 for the equilibrium catholyte chemistry. The new predicted values are then evaluated at 60 to assess whether the proposed changes result in an equilibrium catholyte chemistry that meets the process specifications 62.

As noted above, the method of the present invention uses a relationship between values of at least two characteristics of the process when the process is at equilibrium to predict a value for a first characteristic of the process. Examples of two characteristics of an electrochemical deposition process at equilibrium that are useful to provide such relationship include ion-permeable barrier current density and anolyte pH at equilibrium. The relationship between other process characteristics can also be used to predict a value for a first process characteristic in accordance with the present invention. For example, relationships between number of wafers plated, tool usage, total current, current density or idle time and catholyte copper concentration, anolyte copper concentration, acid gradient across the membrane, molar gradients across the membrane or water volume could be used instead of the relationship between the ion-permeable barrier current density and the anolyte pH at equilibrium.

The relationship between ion-permeable barrier current density and anolyte pH at equilibrium can be determined a number of ways; the way that this relationship is determined is not critical to the present invention. For example, the relationship between ion-permeable barrier current density and anolyte pH at equilibrium can be determined by identifying how the pH of the anolyte at equilibrium changes as a function of the current density across the ion-permeable barrier. This relationship can be determined empirically by using a test cell or a reactor of a particular configuration by passing varying current levels through membranes of known area and measuring values of anolyte pH that the test cell or reactor reach after an extended period of time at the specific current levels.

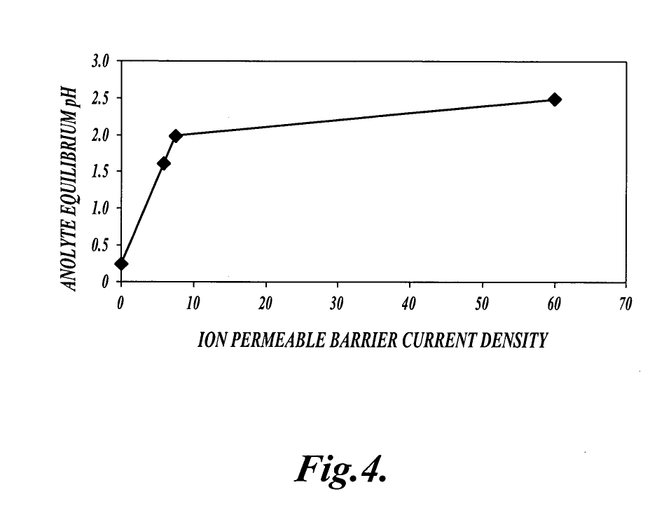

FIG. 4 illustrates a representative relationship between ion-permeable barrier current density and anolyte equilibrium pH for a particular chamber configuration and plating chemistry.

Ion-permeable barrier current density is a function of the area of the ion-permeable barrier provided by the electrochemical treatment chambers of the tool. Referring to FIG. 5, a method of determining ion-permeable barrier current density is described. With the known characteristics of wafer size 200, the chamber barrier area 210 is known based on the specific chamber configuration which may vary from chamber to chamber. In addition, the number of chambers present per tool is also a known characteristic of a process and is a function of the specific tool configuration. Referring to FIG. 5, from the size of the wafer 200 and the chamber configuration, the chamber barrier area 210 is determined. The chamber ion-permeable barrier area 210 is multiplied by the number of chambers per tool which results in a value for the total active ion-permeable barrier area 230 for the tool at 230.

The known value of tool usage per day in

$$\frac{amp - min}{day}$$

is converted to average current in amps at 240 by multiplying the tool usage per day by

$$\frac{1 day}{1440 min} .$$

Dividing the average current across the barrier by the total active barrier area for the tool at 250 provides a value for ion-permeable barrier current density.

From the known value of the starting anolyte pH, the equivalent anolyte acid concentration at startup can be approximated from the equation:

$${10}^{- ( starting anolyte pH )} \times 98.06 \frac{grams}{mole} ( molecular weight of {H}_{2} {SO}_{4} ) \qquad ( 1 )$$

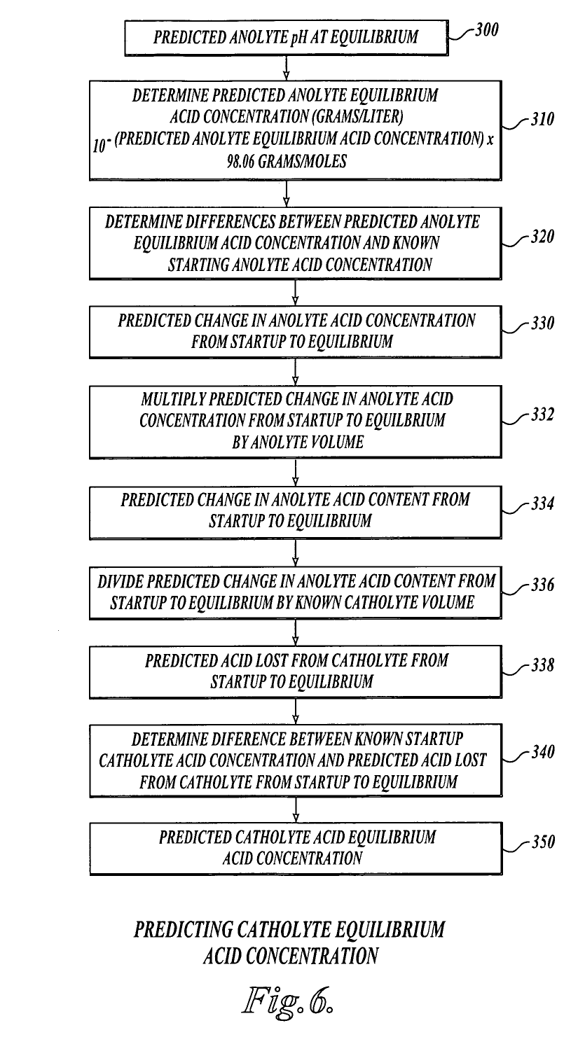

Referring to FIG. 6, the catholyte acid concentration at equilibrium can be predicted as described below. Anolyte pH at equilibrium 300 is predicted from the relationship between anolyte pH at equilibrium and ion-permeable barrier current density (illustrated in FIG. 4) using the known ion-permeable barrier current density. From the predicted anolyte pH at equilibrium 300, the predicted anolyte equilibrium acid concentration can be determined at 310 from the equation:

$${10}^{- ( predicted anolyte pH at equilibrium )} \times 98.06 \frac{grams}{mole} ( molecular weight of {H}_{2} {SO}_{4} ) \qquad ( 2 )$$

The difference between the predicted anolyte equilibrium acid concentration and the known starting anolyte acid concentration is determined at 320 and provides a value for a predicted change in anolyte acid concentration from startup to equilibrium 330. This predicted change in anolyte acid concentration 330 is multiplied by the known anolyte volume at 332 to provide a predicted change in anolyte acid content (grams) from startup to equilibrium 334. The acid gained by the anolyte to reach equilibrium is the same amount as the acid lost from the catholyte to reach equilibrium. The predicted change in anolyte acid content from startup to equilibrium 334 is divided at 336 by the known catholyte volume to predict a value for acid lost from the catholyte from startup to equilibrium 338. The known startup catholyte acid concentration and the predicted acid lost from the catholyte from startup to equilibrium can be used at 340 to predict a catholyte equilibrium acid concentration 350 by taking the difference between these two values.

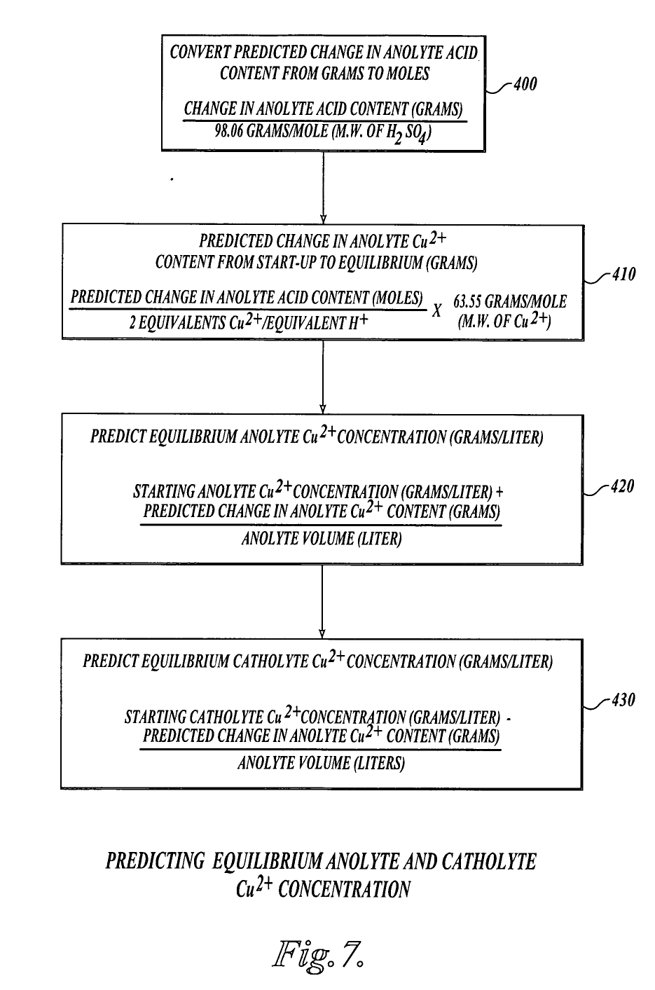

Referring to FIG. 7, a predicted equilibrium anolyte Cu²⁺ concentration can be determined as follows. The predicted change in anolyte acid content (in grams) 334 in FIG. 6 can be converted at 400 to moles by dividing the change in anolyte acid content (in grams) by the molecular weight of H₂SO₄ (98.06 grams/mole). A predicted change in anolyte Cu²⁺ content from startup to equilibrium 410 is determined from the following equation:

$$\frac{Predicted Change in Anolyte Acid Content ( moles )}{2 equivalents {Cu}^{2 +} / 1 equivalent {H}^{+}} \times 63.55 \frac{grams}{moles} ( Molecular Weight of {Cu}^{2 +} ) \qquad ( 3 )$$

An equilibrium anolyte Cu²⁺ concentration 420 can then be predicted using the known starting anolyte Cu²⁺ concentration and the predicted change in anolyte Cu²⁺ content 410 from the following equation:

$$Starting Anolyte {Cu}^{2 +} Concentration ( \frac{grams}{liters} ) + \frac{Change in Anolyte {Cu}^{2 +} Content ( grams )}{Anolyte Volume ( liter )} \qquad ( 4 )$$

The equilibrium catholyte Cu²⁺ concentration 430 can then be predicted using the known starting catholyte Cu²⁺ concentration and the predicted change in anolyte copper content 410 using the following equation:

$$Starting Catholyte {Cu}^{2 +} Concentration ( \frac{grams}{liters} ) - \frac{Predicted Change in Anolyte {Cu}^{2 +} Content ( grams )}{Anolyte Volume ( liter )} \qquad ( 5 )$$

The resulting predicted equilibrium catholyte Cu²⁺ concentration 430 and the catholyte equilibrium acid concentration 350 can be compared to the values for these characteristics set by process specification. Based on this comparison of one or both of the equilibrium catholyte Cu²⁺ concentration and/or the catholyte equilibrium acid concentration, the need for changes to other characteristics of the process are identified and evaluated.

In a specific embodiment, a method of the present invention can be used to determine if an electrochemical plating process is functioning properly. For example, an anolyte pH value or copper concentration value at equilibrium can be predicted as explained above. These predicted values can be compared to actual values for the pH and copper concentration of the anolyte. The degree to which the predicted anolyte pH value or predicted copper concentration value for the anolyte vary from the actual values can provide an indication that the system is not functioning properly. For example, a predicted anolyte pH value that differs from the actual value by more than a predetermined amount may indicate that catholyte is leaking into the anolyte solution.

In another specific embodiment, methods of the present invention can be used to evaluate production capacity of a tool or if a plating chemistry in a particular state is capable of sustaining a certain volume of production. For example, using known values for the existing concentration of Cu²⁺ and acid in the anolyte and catholyte, which may not be the starting values if the process has been running for a period of time, and a future predicted tool usage that would provide 100% tool utilization, or some smaller but representative fraction, the predicted catholyte concentrations for Cu²⁺ and/or acid concentration at equilibrium can be predicted as described above and then compared to predetermined process specifications for the catholyte at equilibrium. Predicted values within the specified range would indicate that the anolyte and catholyte chemistries in their current state would support the desired level of tool usage. On the other hand, predicted values falling outside the specified range would indicate that the chemistries would not support the desired tool usage. To achieve the desired level of tool usage while maintaining the catholyte chemistry within the process specifications, changes to other process characteristics would be identified and evaluated to determine if acceptable catholyte chemistry equilibrium could be achieved at the desired level of tool usage. Possible changes to the process characteristics have been described above.

Methods of the present invention are also useful to determine the number of plating chambers that are required to maintain a catholyte chemistry within process specifications. Using the existing catholyte and anolyte copper and acid concentrations, amount of tool usage, setting the predicted value for the equilibrium catholyte Cu²⁺ concentration as a known characteristic based on an upper limit of the process specification, and using the relationships described above with reference to FIGS. 3-7, the number of chambers required to maintain the catholyte chemistry in specification. This predicted value can be used to determine how many chambers can/should be placed into an idle state in order to maintain the catholyte chemistry within process specifications.

In another specific embodiment, methods of the present invention can be used to determine whether an anolyte chemistry should be replaced when changing the catholyte chemistry. For example, using the known existing anolyte copper concentration and acid concentration, new starting catholyte Cu²⁺ and acid concentrations, and the expected future tool usage, predicted equilibrium catholyte Cu²⁺ and acid concentrations can be determined using the relationships discussed above with reference to FIGS. 3-7. These predicted values can be compared to values set by the process specification. A decision to change the anolyte could be based on whether the predicted values for equilibrium catholyte Cu²⁺ concentration and/or acid concentration fall outside of the process specifications by a predetermined amount.

Methods of the present invention can also be implemented in an automated process control system that provides and/or implements suggested process changes to maintain processing fluid chemistry within process specifications. For example, the suggested process changes could be to either drain and/or replenish the processing fluid(s) chemistry or to pass current to an auxiliary electrode system. With the known characteristics of existing anolyte and catholyte Cu²⁺ concentration and acid concentration and an expected tool usage, predicted values for process characteristics can be determined, as described above, with the added benefit that the process control system would suggest or implement a specific action to be performed by the tool or the operator to make adjustments so that the chemistry remains within specifications.

Referring back to FIG. 2, the operation of system 100 occurs, in part, by selecting suitable concentrations of the ionic processing fluid components, hydrogen ions (i.e., acid protons) and copper ions. In several useful processes for depositing copper, the acid concentration in the first processing fluid can be approximately 5 g/l to approximately 200 g/l, and the acid concentration in the second processing fluid can be approximately 0.01 g/l to approximately 10.0 g/l or a pH of about 1 to 4. Alternatively, the acid concentration of the first and/or second processing fluids can be outside of these ranges. For example, the first processing fluid can have a first concentration of acid and the second processing fluid can have a second concentration of acid less than the first concentration. The ratio of the first concentration of acid to the second concentration of acid, for example, can be approximately 10:1 to approximately 20,000:1. The concentration of copper is also a parameter. For example, in many copper plating applications, the first and second processing fluids can have a copper concentration of between approximately 10 μl and approximately 50 g/l.

When the first processing fluid is a catholyte, the first processing fluid can be characterized as a “high acid” catholyte bath. A high acid catholyte bath may include about 120-200 μl acid concentration and about 10-40 g/l copper ion concentration. The first processing fluid can also be a catholyte that contains less acid and can be characterized as a “moderate acid” catholyte. A moderate acid catholyte can include about 45-120 g/l acid concentration and about 40-50 g/l copper ion concentration. The first processing fluid can have even less acid and be characterized as a “low acid” catholyte. A low acid catholyte can include about 5 g/l-45 g/l acid concentration and about 40-50 g/l copper ion concentration. In addition, these types of baths may include small amounts, e.g., about 10-100 ppm hydrochloric acid.

When the second processing fluid is an anolyte, it may comprise about 0.01-10.0 g/l acid concentration and about 10-50 g/l copper ion concentration, which results in a pH between about 1 to 4. A narrower range of acid concentration for an anolyte is about 0.1-1.0 g/l. Like the catholyte, the anolyte may include about 10-100 ppm hydrochloric acid. Although the foregoing ranges are useful for many applications, it will be appreciated that the first and second processing fluids can have other concentrations of copper and/or acid.

In other embodiments, an ion-permeable barrier 170 can be anionic and electrode 190 in FIG. 2 can be an inert anode (i.e., platinum or iridium oxide) to prevent the accumulation of sulfate ions in the first processing fluid. In these embodiments, the acid concentration or pH in the first and second processing fluids can be similar. Alternatively, the second processing fluid may have a higher concentration of acid to increase the conductivity of the fluid. Copper salt (e.g., copper sulfate) can be added to the first processing fluid to replenish the copper in the fluid. Electric current can be carried through the ion-permeable barrier by the passage of sulfate anions from the first processing fluid to the second processing fluid. Therefore, sulfate ions are less likely to accumulate in the first processing fluid where they can adversely affect the deposited film.

In other embodiments, the system can electrochemically etch copper from the workpiece. In these embodiments, the first processing solution (the anolyte) contains an electrolyte that may include copper ions. During electrochemical etching, a potential can be applied to the electrode and the workpiece. The ion-permeable barrier is chosen to prevent positive ions (such as copper) from passing into the second processing fluid (catholyte). Consequently, the current is carried by anions, and copper ions are inhibited from flowing proximate to and being deposited on the electrode.

In addition to the non-porous barriers described above, ion-permeable barrier 170 in FIG. 2 can also be a porous barrier. Porous barriers include substantial amounts of open space or pores that permit fluid to pass through the porous barrier. Both ionic components and non-ionic components are capable of passing through a porous barrier; however, passage of certain components may be limited or restricted if the components are of a size that allows the porous barrier to inhibit the passage of such components. While porous barriers may limit the chemical transport (via diffusion and/or convection) of some components in the first processing fluid and the second processing fluid, they allow migration of anionic and cationic species (enhance passage of current) during application of electric fields associated with electrolytic processing. In the context of electrochemical processing wherein copper ions are present in the anolyte and catholyte, a porous barrier enables migration of ionic species, including copper ions, across the porous barrier while limiting diffusion or mixing (i.e., transport across the barrier) of larger organic components between the anolyte and catholyte. The ionic species are driven across the porous barrier by migration (movement in response to the imposed electric field). Thus, porous barriers permit maintaining different chemical compositions for the anolyte and the catholyte. The porous barriers should be chemically compatible with the processing fluids over extended operational time periods. Examples of suitable porous barrier layers include porous glasses (e.g., glass frits made by sintering fine glass powder), porous ceramics (e.g., alumina and zirconia), silica aerogel, organic aerogels (e.g., resorcinol formaldehyde aerogel), porous polymeric materials, such as expanded Teflon® (GORE-TEX®). Suitable porous ceramics include grade P-6-C available from Coorstek of Golden, Colo. An example of a suitable porous barrier is a porous plastic, such as Kynar, a sintered polyethylene or polypropylene. Such materials can have a porosity (Boyd fraction) of about 25%-85% by volume with average pore sizes ranging from about 0.5 to about 20 micrometers. Such porous plastic materials are available from Poretex Corporation of Fairbum, Ga. These porous plastics may be made from three separate layers of material that include a thin, small pore size material sandwiched between two thicker larger pore size sheets. An example of a product useful for the middle layer having small pore size is Celgard 2400, made by Celgard Corporation, a division of Hoechst, of Charlotte, N.C. The outer layers of the sandwich construction can be a material such as ultrafine grade sintered polyethylene sheet, available from Poretex Corporation. The porous barrier materials allow fluid flow across themselves in response to the application of pressures normally encountered in an electrochemical treatment process, e.g., pressures normally ranging from about 6 psi and below.

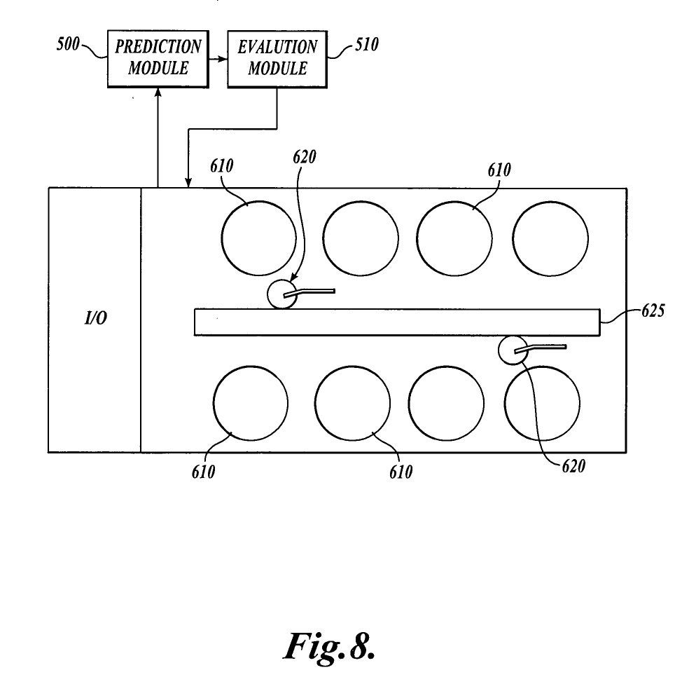

Referring to FIG. 8, in accordance with another aspect of the present invention, a system is provided for managing an electrochemical treatment process of a microfeature workpiece that includes an electrochemical treatment chamber having an ion-permeable barrier described above. In accordance with this aspect of the present invention, a prediction module 500 is provided for predicting a first characteristic of a process carried out in the electrochemical treatment chamber in accordance with the methods of the present invention described above. The prediction module 500 uses a relationship between values for at least two characteristics of the process when the process is at equilibrium to predict the first characteristic of the process. The output of the prediction module 500 is received by an evaluation module 510 that uses the predicted value for the first characteristic to evaluate whether changes to other characteristics of the process are necessary. As described above, the evaluation module can carry out the evaluation a number of ways. For example, the evaluation module can compare the predicted value for the characteristic to predetermined values for the same characteristic and ascertain whether or not the difference between the values warrants a change to other characteristics of the process. If changes are warranted, the evaluation module generates a signal intended to result in the desired change being made by a control system (not shown) for the tool.

The methods and systems of the present invention can be used with a processing tool such as an electroplating apparatus available from Semitool, Inc., of Kalispell, Mont. Continuing to refer to FIG. 8, such a processing tool may include a plurality of processing stations 610, one of which may be a chamber for electrochemically treating a microfeature workpiece. Other suitable processing stations include one or more rinsing/drying stations and other stations for carrying out wet chemical processing. The tool also may include a robotic member 620 that is carried on a central track 625 for delivering workpieces from an input/output location to the various processing stations.

While a preferred embodiment of the invention has been illustrated and described, it will be appreciated that various changes can be made therein without departing from the spirit and scope of the invention.

The embodiments of the invention in which an exclusive property or privilege is: claimed are defined as follows:

1. A method of managing a process for electrochemically treating a surface of a microfeature workpiece in an electrochemical treatment chamber that includes a processing unit for receiving a first processing fluid separated by an ion-permeable barrier from an electrode unit for receiving a second processing fluid comprising:
predicting a value for a first characteristic of the process using a relationship between values for at least two characteristics of the process when the process is at equilibrium;
using the predicted value for the first characteristic to evaluate whether a change to another characteristic of the process is necessary.

2. The method of claim 1, wherein the using step comprises comparing the predicted value for the first characteristic to an actual value of the first characteristic and evaluating whether a change to another characteristic of the process is necessary based on the results of the comparison.

3. The method of claim 1, wherein the using step comprises comparing the predicted value for the first characteristic to a predetermined value for the first characteristic and evaluating whether a change to another characteristic of the process is necessary based on the results of the comparison.

4. The method of claim 1, wherein the first characteristic is metal ion concentration in the first processing fluid or the second processing fluid.

5. The method of claim 4, wherein the first processing fluid is a catholyte, the second processing fluid is an anolyte, and the at least two characteristics are ion-permeable barrier current density and pH of the anolyte at equilibrium.

6. The method of claim 1, wherein the first characteristic is acid concentration of the first processing fluid or the second processing fluid.

7. The method of claim 6, wherein the first processing fluid is a catholyte, the second processing fluid is an anolyte, and the at least two characteristics of the process are ion-permeable barrier current density and pH of the anolyte at equilibrium.

8. The process of claim 1, wherein the first characteristic is a non-equilibrium characteristic of the process.

9. The method of claim 8, wherein the first characteristic is selected from the group consisting of copper concentration in the first or second processing fluid, acid concentration of the first or second processing fluid, first processing fluid volume, second processing fluid volume, number of chambers in a tool, tool usage, number of active chambers, average current, ion-permeable barrier density, acid gradient across the membrane and molar gradient across the membrane.

10. The method of claim 1, further comprising a step of implementing a change to another characteristic of the electrochemical treatment process.

11. A system for managing an electrochemical treatment process of a microfeature workpiece that includes an electrochemical treatment chamber having a processing unit for receiving a first processing fluid separated by an ion-permeable barrier from an electrode unit for receiving a second processing fluid comprising:
a prediction module for predicting a first characteristic of a process carried out in the electrochemical treatment chamber, the prediction module using a relationship between values for at least two characteristics of the process when the process is at equilibrium to predict the first characteristic of the process; and
an evaluation module for using the predicted value for the first characteristic to evaluate whether a change to another characteristic of the process is necessary.

12. The system of claim 11, wherein the first characteristic is a characteristic of the process at equilibrium.

13. The system of claim 12, wherein the first characteristic is metal ion concentration of the first processing fluid or the second processing fluid.

14. The system of claim 13, wherein the first processing fluid is a catholyte, the second processing fluid is an anolyte, and the at least two characteristics of the process are ion-permeable barrier current density and pH of the anolyte at equilibrium.

15. The system of claim 12, wherein the first characteristic is acid concentration of the first processing fluid or the second processing fluid.

16. The system of claim 15, wherein the first processing fluid is a catholyte, the second processing fluid is an anolyte, and the at least two characteristics of the process are ion-permeable barrier current density and pH of the anolyte at equilibrium.

17. The system of claim 11, wherein the first characteristic is a non-equilibrium characteristic of the process.

18. The system of claim 17, wherein the first characteristic of the process is selected from the group consisting of copper concentration in the first or second processing fluid, acid concentration of the first or second processing fluid, first processing fluid volume, second processing fluid volume, number of chambers in a tool, tool usage, number of active chambers, average current, ion-permeable barrier current density, acid gradient across the membrane and molar gradient across the membrane.

19. The system of claim 11, further comprises a control system that receives a signal from the evaluation module and implements a change to a characteristic of the electrochemical treatment process.

20. A method for predicting an equilibrium characteristic of a process for electrochemically treating a surface of a microfeature workpiece in an electrochemical treatment chamber that includes a processing unit for receiving a first processing fluid separated by an ion-permeable barrier from an electrode unit for receiving a second processing fluid comprising:
predicting a value for a first characteristic of the process at equilibrium, other than pH of the second processing fluid at equilibrium or ion-permeable barrier current density, using a relationship between ion-permeable barrier current density and pH of the second processing fluid at equilibrium.

21. The method of claim 20, wherein the first characteristic is metal ion concentration of the first processing fluid at equilibrium.

22. The method of claim 20, wherein the first characteristic is acid concentration of the first processing fluid at equilibrium.
